(19) United States
(12) Patent Application Publication
(10) Pub. No.: US 2006/0207850 A1
(43) Pub. Date: Sep. 21, 2006

(54) Luggage handle with integral weight scale

(76) Inventor: John Joseph Lewis, San Jose, CA (US)

Correspondence Address: SAWYER LAW GROUP LLP, P O BOX 51418, PALO ALTO, CA, 94303, US

(21) Appl. No.: 11/084,764

(22) Filed: Mar. 18, 2005

(51) Int. Cl. A45C 13/30; G01G 19/56; A45C 13/00

(52) U.S. Cl. 190/115; 177/131

(57) ABSTRACT

The present invention provides airline travelers with a method of determining baggage weight compliance while traveling, prior to having baggage rejected or additional fees assessed at the baggage check counter at the airport. In a first aspect, a luggage comprises a body portion and a handle coupled to the body portion. The handle includes a scale therewithin for determining the weight of the luggage. In a second aspect, a handle for a piece of luggage comprises a handle shell and a scale within the handle shell. The handle includes a mechanism coupled to the handle shell for attaching the handle shell to the luggage.

### FIELD OF THE INVENTION

The present invention relates generally to luggage and more specifically to the weighing of luggage.

### BACKGROUND OF THE INVENTION

Often at airports and other such locations there is a weight limit for each piece of luggage. If one or more pieces of a customer's luggage exceeds this weight limit, then additional fees are assessed. Also, the traveler must then either find a way to reduce the weight and contents of the luggage or pay for an additional piece of luggage. In addition to the inconvenience experienced by the traveler and the additional fees, the traveler may have to miss a scheduled flight and as a result suffer even greater inconvenience and expense.

Placing luggage bags on a typical home scale, such as a bathroom scale, is a clumsy and difficult process. Oftentimes the display of the scale is covered by the luggage, which may be much larger and bulkier in size than the scale. It is also difficult to place luggage on a home scale and to keep it steady without holding it and thereby affecting the weight measurement. Each time the luggage needs to be weighed with a conventional home scale, the suitcase or bag must be closed before attempting to place it on the small-sized scale. What is needed is a method by which a customer can weigh luggage as it is being packed, to make sure that it fits within required weight limits before it taken to the airport or location for transport. The present invention meets this need.

### SUMMARY OF THE INVENTION

The present invention provides airline travelers with a method of determining baggage weight compliance while traveling, prior to having baggage rejected or additional fees assessed at the baggage check counter at the airport. In a first aspect, a luggage comprises a body portion and a handle coupled to the body portion. The handle includes a scale therewithin for determining the weight of the luggage. In a second aspect, a handle for a piece of luggage comprises a handle shell and a scale within the handle shell. The handle includes a mechanism coupled to the handle shell for attaching the handle shell to the luggage.

### BRIEF DESCRIPTION OF THE DRAWINGS

FIG. 1 shows a suitcase with a handle, attachment fittings and a scale located in the handle in accordance with the present invention.

FIG. 2 is a detailed illustration of the handle of the suitcase in accordance with the present invention.

### DETAILED DESCRIPTION

The present invention relates to generally to luggage and more specifically to the weighing of luggage. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides an individual with a method for determining the weight of a piece of luggage (a suitcase, for example) without using a standalone utility scale.

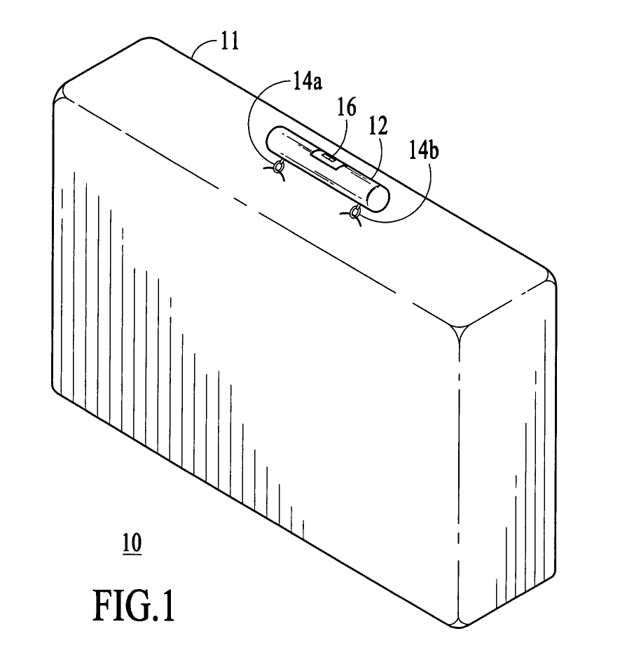

FIG. 1 shows a suitcase 10 in accordance with the present invention. The suitcase 10 includes a body portion 11 and a handle 12. The suitcase 10 further includes attachment fittings 14a and 14b which attach the handle 12 to the suitcase, and a weight scale 16 located in the handle in accordance with the present invention.

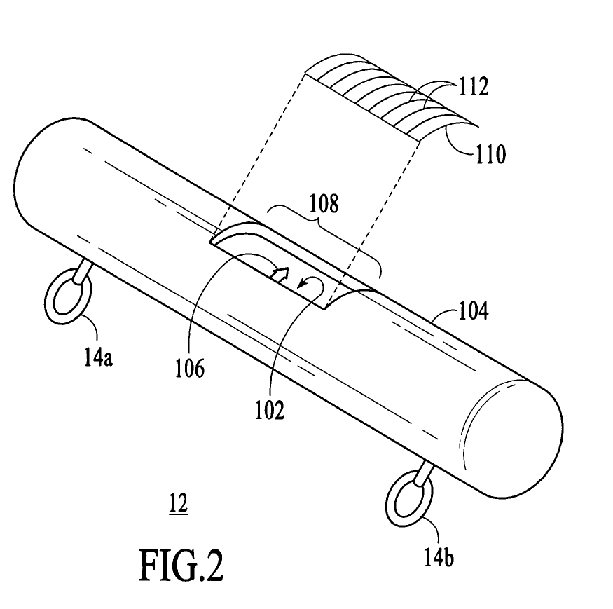

FIG. 2 is a partially expanded illustration of the handle 12′ of the suitcase 10′ in accordance with the present invention. The handle 12′ includes attachment points 14a and 14b, a spring or compression scale 102, a window 210 with an indicator scale 212. Attachment points 14a and 14b are used to attach the handle 12′ to the suitcase or piece of luggage (not shown). The attachment points 14a-14b may be permanently connected to the body 11 of the suitcase or they may be detachable, allowing the handle 12′ to detach from the suitcase body 11. The attachment points 14a-14b connect to a spring or compression scale 102 which is contained within the handle shell 104. The handle 12′ is fitted with an opening 108. and a spring or compression scale 102 within the handle shell 104.

As is seen in FIG. 2, a window 110 with an indicator scale 112 fits within the opening 108 in the handle shell, thereby covering the spring scale 102 and the scale pointer 106. The window 110 could be made from any kind of clear material such as plastic, glass, or any other transparent material. The indicator scale 112 has markings on it which indicate weight in pounds, ounces, a metric scale, or other measurement scales, and is calibrated to include the total weight of the suitcase and handle/scale combination, so that an accurate weight reading may be determined. When a person lifts the suitcase from a surface so that the suitcase is supported only by the person holding the suitcase, the scale pointer 106 will point to markings on the indicator scale 212 which indicate the weight of the suitcase. In this way a person may determine the weight of the suitcase.

The markings on the indicator scale, as indicated above, may be displayed in pounds, ounces, the metric system, or in any other desired weight measurement system. It would also be possible to utilize markings on the indicator scale which indicate weight limits imposed by specific airlines, transport companies, mailing systems or the like.

Although the present invention has been described in accordance with the embodiments shown, one of ordinary skill in the art will readily recognize that there could be variations to the embodiments and those variations would be within the spirit and scope of the present invention. Although two attachment points are utilized in the preferred embodiment, one of ordinary skill in the art readily recognizes that a plurality of attachment points could be utilized and that they would be within the spirit and scope of the present invention. Additionally, one of ordinary skill in the art readily recognizes that the scale could utilize a digital readout, and be within the spirit and scope of the present invention.

Although a suitcase is shown as a preferred embodiment, one of ordinary skill in the art readily recognizes that other types of pieces of luggage may be utilized, such as bags or containers of various kinds, and that they would also be within the spirit and scope of the present invention.

Accordingly, many modifications may be made by one of ordinary skill in the art without departing from the spirit and scope of the appended claims.

What is claimed is:

1. A luggage comprising:
a body portion; and
a handle coupled to the body portion, wherein the handle includes a scale therewithin for determining the weight of the luggage.

2. The luggage of claim 1 which comprises any of a suitcase, a carrying bag and container.

3. The luggage of claim 1 wherein the handle comprises:
a handle shell;
a scale within the handle shell; and
a mechanism coupled to the handle shell for attaching the handle shell to the luggage.

4. The luggage of claim 3 wherein the mechanism comprises first and second attachment points on the ends of the handle shell.

5. The luggage of claim 3 wherein the scale has measurement markers.

6. The luggage of claim 5 wherein the measurement markers depict pounds.

7. The luggage of claim 5 wherein the measurement markers depict grams.

8. The luggage of claim 5 wherein the measurement markers contain specific markings of weight limits determined by transport, airline, or mailing companies.

9. The luggage of claim 5 wherein the scale comprises a digital readout.

10. The luggage of claim 5 wherein a window with an indicator scale fits over the scale, the window being manufactured from any transparent material.

11. A handle for a piece of luggage comprising:
a handle shell;
a scale within the handle shell; and
a mechanism coupled to the handle shell for attaching the handle shell to the luggage.

12. The luggage of claim 11 wherein the mechanism comprises first and second attachment points on the ends of the handle shell.

13. The handle of claim 11 wherein the scale has measurement markers.

14. The handle of claim 13 wherein the measurement markers depict pounds.

15. The handle of claim 13 wherein the measurement markers depict grams.

16. The handle of claim 13 wherein the measurement markers contain specific markings of weight limits determined by transport, airline, or mailing companies.

17. The handle of claim 13 wherein the readout mechanism comprises a digital readout.

18. The handle of claim 13 wherein a window with an indicator scale fits over the scale, the window being manufactured from any transparent material.

19. A suitcase comprising:
a body portion; and
a handle coupled to the body portion, wherein the handle includes a scale therewithin for determining the weight of the luggage, wherein the handle comprises a handle shell; a scale within the handle shell; and a mechanism coupled to the handle shell for attaching the handle shell to the luggage, wherein the mechanism comprises first and second attachment points on the ends of the handle shell.
